(19) United States
(12) Patent Application Publication
(10) Pub. No.: US 2003/0131166 A1
(43) Pub. Date: Jul. 10, 2003

(54) Information processing system and interface apparatus

(75) Inventors: Shin-Ichi Utsunomiya, Kawasaki (JP); Hirohide Sugahara, Kawasaki (JP); Katsuhiko Takeuchi, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/273,528

(22) Filed: Oct. 18, 2002

(30) Foreign Application Priority Data
Jan. 10, 2002 (JP) 2002-003397

(51) Int. Cl. G06F 13/12

(52) U.S. Cl. 710/74

(57) ABSTRACT

An information processing system is provided. The information processing system includes a drive apparatus and a host apparatus in which the drive apparatus executes a command issued by the host apparatus. The information processing system further includes an interface part for reading a command from a command queue including commands issued by the host apparatus and sending the command to the drive apparatus.

### BACKGROUND OF THE INVENTION

1. Field of the Invention

The present invention relates to a drive apparatus. More particularly, the present invention relates to an information processing system including an ATA (AT Attachment) drive apparatus, an interface apparatus, an information processing apparatus connecting to an information storage, and the information storage.

2. Description of the Related Art

SCSI (Small Computer System Interface) and ATA (AT Attachment) are known as conventional standards for controlling a disk apparatus. A method for issuing a command from a CPU, which is a host apparatus, to a disk apparatus is different between SCSI and ATA. In SCSI, since a command queuing function is defined for queuing a plurality of commands, the CPU can issue a next command without waiting for execution of a previous command. On the other hand, as for ATA, since there is no function to receive a plurality of commands, the CPU needs to issue commands one by one.

In the following, a command issuing method in ATA will be described with reference to FIG. 1. FIG. 1 shows a CPU 14, a main memory 16 that is a RAM (Random Access Memory), an interface 13 that interfaces an AT bus and a system bus, and an AT drive apparatus 12, which are a part of a personal computer. These components are connected by a system bus and an AT bus. FIG. 2 shows the command issuing method of the CPU 14 in this structure. First, the CPU 14 refers to a status register of the AT drive apparatus 12. When the CPU 14 determines that the status of the AT drive apparatus 12 is not busy, the CPU 14 directly writes an AT register set, which is a command to the AT drive apparatus 12, to a task file of the AT drive apparatus 12 in step 1. When the status is busy, the CPU 14 polls the status register in step 2. When the busy status is released, the CPU 14 performs the step 1. When the AT register set is written to the task file in step 1, the AT drive apparatus 12 starts to execute the command. When the execution of the command ends, the AT drive apparatus 12 asserts an INTRQ signal (an interrupt signal) in the CPU 14 (sends an INTRQ signal to the CPU 14). The CPU 14, which receives the INTRQ signal, checks the processing result by reading the AT register set in step 3. Then, if the status register is not busy, a command to be executed next is written to the task file of the AT drive apparatus 12.

As mentioned above, the CPU 14 needs to perform the processes of steps 1-3. Thus, work load of the CPU 14 is becoming larger as processing speed and bus transfer speed of the AT drive apparatus continue the increases of recent years.

### SUMMARY OF THE INVENTION

An object of the present invention is to provide an information processing system, an information processing apparatus connecting to a drive apparatus, and an interface apparatus for allowing the CPU to issue a plurality of commands to the drive apparatus at the same time.

The above object can be achieved by an information processing system including a drive apparatus and a host apparatus (information processing apparatus) wherein the drive apparatus executes a command issued by the host apparatus, the information processing system including an interface part for reading a command from a command queue including commands issued by the host apparatus and sending the command to the drive apparatus. The command queue may be stored in a memory in the host apparatus.

According to the above-mentioned invention, work load of the host apparatus for issuing commands can be decreased since the interface apparatus reads the command from a command queue and sends the command to the drive apparatus.

### BRIEF DESCRIPTION OF THE DRAWINGS

Other objects, features and advantages of the present invention will become more apparent from the following detailed description when read in conjunction with the accompanying drawings, in which:

FIG. 1 shows a conventional configuration of a part of a personal computer and an AT drive apparatus;

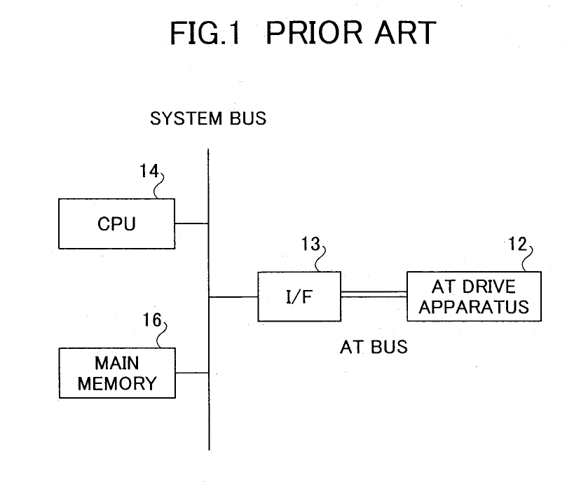

FIG. 2 shows a conventional control method of the AT drive apparatus;

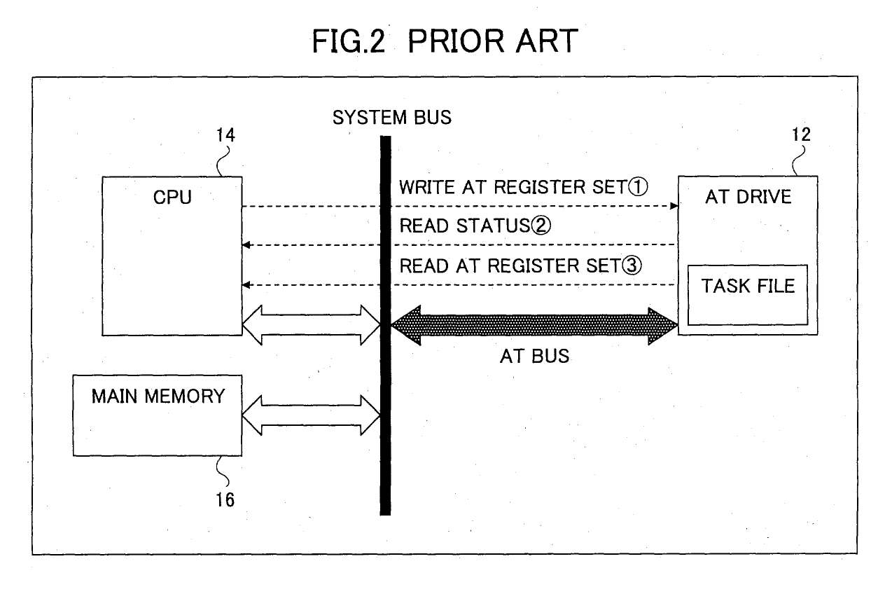

FIG. 3 shows a block diagram of a personal computer that includes an interface apparatus of the present invention;

FIG. 4 shows a control method of the AT drive apparatus according to the present invention;

FIG. 5 shows a control method between the AT drive and a HBA according to the present invention;

FIG. 6 shows a task file queue;

FIG. 7 shows a flow chart of operation of the CPU according to the present invention;

FIG. 8 shows a flow chart of operation of the HBA according to the present invention.

### DETAILED DESCRIPTION OF THE PREFERRED EMBODIMENTS

In the following, an embodiment of the present invention will be described with reference to figures.

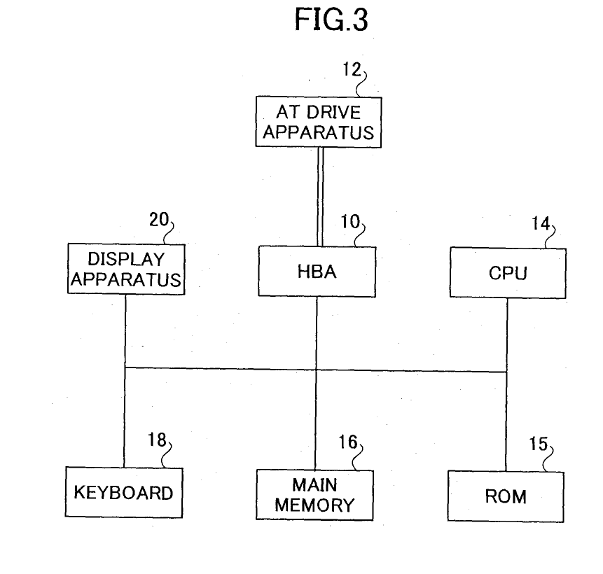

FIG. 3 shows a block diagram of a personal computer that includes an interface apparatus (which will be called HBA (Host Bus Adapter) hereinafter) of an embodiment of the present invention. FIG. 3 shows an HBA 10, an AT drive apparatus 12, a CPU 14, a main memory 16 which is a RAM, a ROM (Read Only Memory) 15 storing firmware, and a display apparatus 20. The AT drive apparatus 12 is an ATA hard disk apparatus. The display apparatus 20 displays information necessary for operating the computer. The keyboard 18 is an input device by which a user operates the personal computer. The CPU 14 executes the firmware stored in the ROM 15. In addition, the CPU 14 performs a series of processes of receiving data by controlling peripheral devices, performing calculations on the data, storing the data in the main memory and outputting process results to the peripheral devices. The HBA 10 reads information successively from an later-mentioned task file queue in which AT register sets, which are commands from the CPU 14, are stored, and transfers the information to the AT drive apparatus 12. Although the AT register sets are written in the main memory 16, the HBA 10 may include a memory such that the AT register sets are written to the memory of the HBA 10.

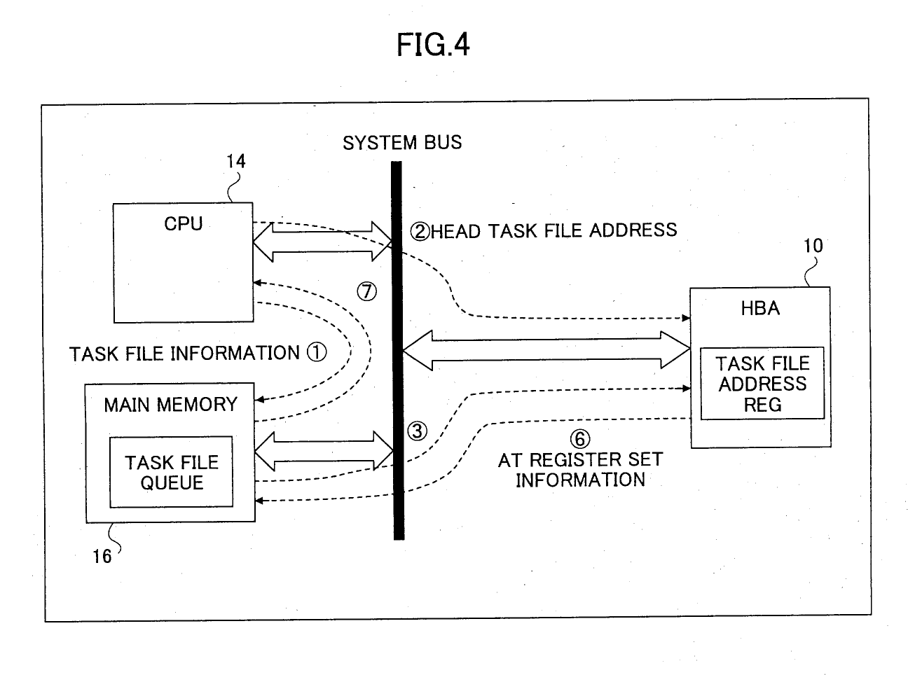

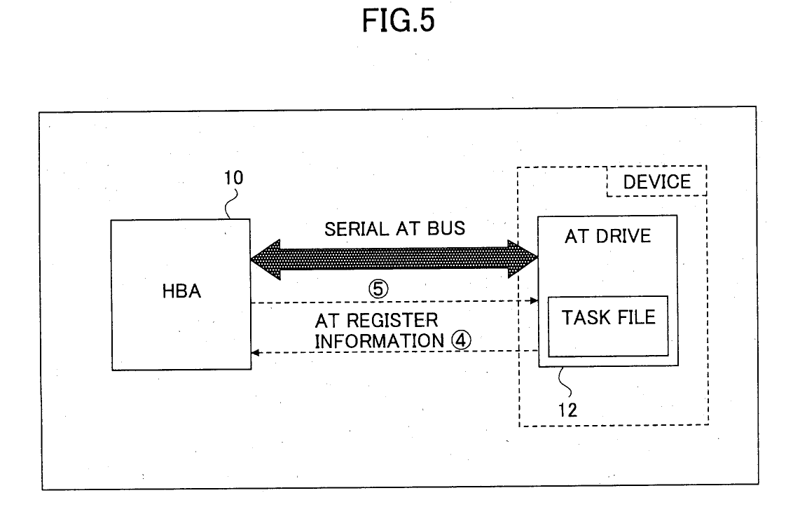

In the following, a series of processes will be described by using FIGS. 4 and 5 in which the CPU 14 issues multiple commands at the same time and the HBA 10 transfers the commands.

When the CPU 14 issues an AT register set (a command), the CPU 14 does not write the command directly to the task file in the AT drive apparatus 12, which is different from the conventional technique. The CPU 14 writes the AT register set and later-mentioned additional information in the main memory 16 as a task file via a system bus in step 1. Then, the CPU 14 writes the head address of the AT register set to a task file address register of the HBA 10 in step 2. The HBA 10 reads the AT register set from the main memory in step 3. Then, the HBA 10 writes the AT register set to the task file of the AT drive apparatus 12 in step 5 of FIG. 5. Then, the AT drive apparatus 12 executes the task. After the task is completed, the HBA 10 reads the execution result from the AT drive apparatus in step 4 (FIG. 5), and writes it to the main memory 16 in step 6 (FIG. 4). Then, the CPU 14 reads the result in step 7. Since the HBA 10 controls the AT drive apparatus 12 by using the main memory 16, it is understood that the work load for the CPU 14 is decreased.

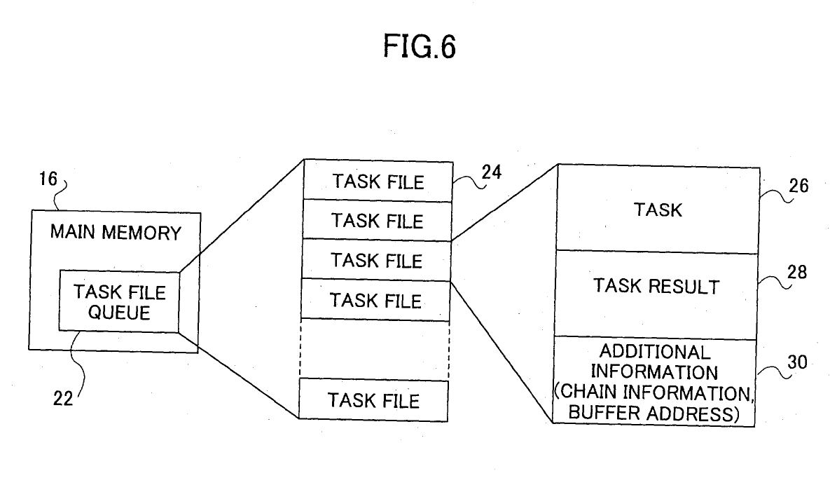

Next, details of the above-mentioned processes and the task file that the CPU 14 writes to the memory will be described. First, the task file will be described with reference to FIG. 6. The task files issued by the CPU 14 are queued as a task file queue 22 in the main memory so that the CPU 14 can issue a plurality of commands at the same time. As shown in FIG. 6, a task file 24 includes a task 26, a task result 28 and additional information 30. The AT register set is stored in the task 26, and a result of execution of the AT register set by the AT drive apparatus 12 is stored in the task result 28. The additional information 30 includes a buffer address, which is chain information The buffer address is a value indicating the head address of the next task file or a value indicating the last task file. The HBA 10 can read a plurality of task files by using the buffer address.

As an example for setting the task file queue 22, a case in which three commands are stored in the queue will be described. First, the CPU 14 reserves a memory space for storing a first command, and holds the head address of the memory space. The head address is an address to be written to the task file address register of the HBA 10. Then, the CPU 14 stores the AT register set (command) in task 26 in the first memory space. Next, the CPU 14 reserves a second memory space, and stores the head address of the second memory space in additional information 30 in the first task file. Then, in the same way as the first task file, the AT register set is stored in task 26 of the second task file. Then, the CPU 14 reserves the last and third memory space, and stores the head address in additional information in the second task file. Then, the CPU 14 stores the AT register set in task 26 of the third task file. Since the task file queue ends at the third task file, additional information of the third task file stores a value indicating the last task file, such as all zeros or all Fs (in hexadecimal).

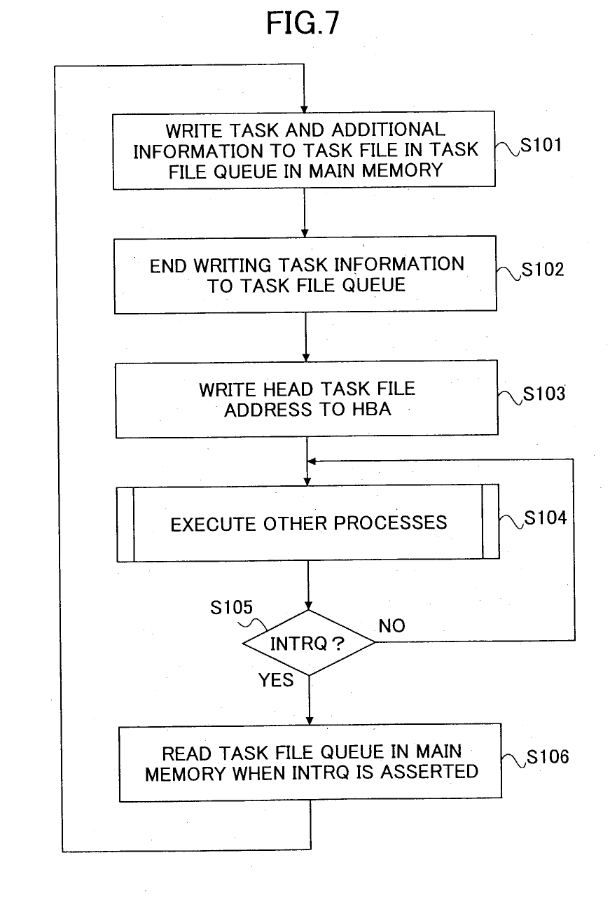

Next, a series of processes of the CPU 14 will be described with reference to the flow chart of FIG. 7. The CPU 14 writes tasks and additional information in the task files to the main memory 16 in step S101. The method of writing is as mentioned above. After the additional information is written in step S102, the head address of the task file queue 22 is written to the task file address register in the HBA 10 in step 103. When the processes described so far are complete, processes for AT drive apparatus 12 hereafter are performed by the HBA 10. Thus, the CPU 14 can perform other processes in step S104 until an interrupt signal is asserted in step S105 When the interrupt signal is asserted in step S105, the CPU 14 reads task results 28 in the task files 24 in the main memory 16 in step S106, so that the CPU 14 can determine the results of execution of issued commands. Accordingly, execution of commands stored in the task queue ends. When commands are issued again, the above-mentioned processes from step 1 are executed.

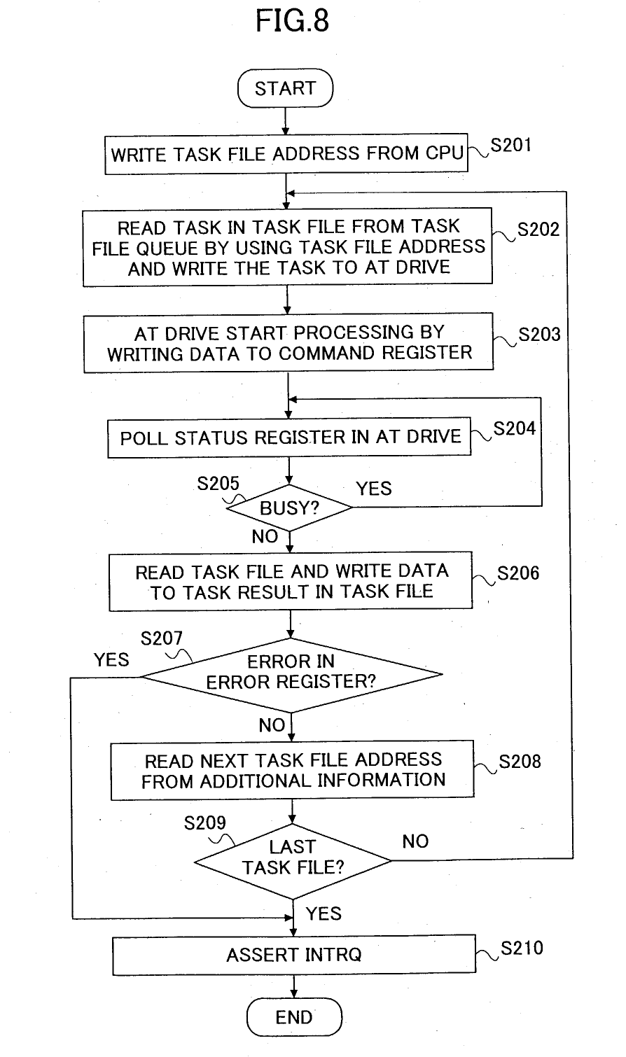

Next, the process of the HBA 10 will be described with reference to the flowchart of FIG. 8. The head address of the task file queue 22 is written in the task file address register by the CPU 14 in step S201. Then, task 26 in the task file 24 is extracted, and the AT register set stored in the task 26 is written to the AT drive apparatus 12 in step 202. The AT drive apparatus 12 starts processing by writing the AT register set in a command register in step 203. Next, the status register of the AT drive apparatus 12 is polled until busy status is released in step 204. When the busy status is released in step 205, the result of execution of command is written to the task result 28 of the task file 24 in step 206. When an error exists in an error register (S207), an interrupt signal is sent to the CPU 14 and the process ends in step 210. When an error does not exist in the error register, an address of a task file to be performed next is read from the additional information in step 208. When the additional information has an address instead of the value indicating the last task file, the process is performed again from step 202. When the value indicating the last task file is stored (Yes in S209), or, when the error register includes an error in step 207, the interrupt signal is sent to the CPU 14 and the process ends in step 210.

As mentioned above, according to the present invention, an interface apparatus is provided between a drive apparatus and a host apparatus, wherein the interface apparatus reads a command from a command queue including commands issued by the host apparatus and sends the command to the drive apparatus. Since the interface apparatus, instead of the host apparatus itself, sends the command to the drive apparatus, load for the host apparatus decreases.

The host apparatus includes a memory for storing the command queue, and the interface apparatus stores an address for accessing the command queue, for which the address is sent from the host apparatus. Therefore, the interface apparatus can read the command from the command queue and sends the command to the drive apparatus.

In addition, the interface apparatus includes a part for storing, in the memory, a result of execution of the command by the drive apparatus, the result being read by the host apparatus when an interrupt signal is sent from the interface part to the host apparatus. Accordingly, the host apparatus can determine the result of the command.

As mentioned above, according to the present invention, an information processing system for allowing a host apparatus to issue a plurality of commands for the drive apparatus at the same time can be realized.

The present invention is not limited to the specifically disclosed embodiments, and variations and modifications may be made without departing from the scope of the present invention.

What is claimed is:

1. An information processing system including a drive apparatus and a host apparatus in which said drive apparatus executes a command issued by said host apparatus, said information processing system comprising:
an interface part for reading a command from a command queue including the commands issued by said host apparatus and sending said command to said drive apparatus.

2. The information processing system as claimed in claim 1, wherein said host apparatus includes a memory for storing said command queue, and said interface part includes a part for storing an address for accessing said command queue.

3. The information processing system as claimed in claim 2, said interface part comprising:
a part for storing, in said memory, a result of execution of said command by said drive apparatus, said result being read by said host apparatus when an interrupt signal is sent from said interface part to said host apparatus.

4. An interface apparatus provided between a host apparatus issuing a command and a drive apparatus executing said command, said interface apparatus comprising:
a part for reading a command from a command queue including the commands issued by said host apparatus and sending said command to said drive apparatus.

5. The interface apparatus as claimed in claim 4, wherein said host apparatus includes a memory for storing said command queue, said interface apparatus comprising:
a part for storing an address for accessing said command queue.

6. The interface apparatus as claimed in claim 4, said interface apparatus comprising:
a part for storing, in said memory, a result of execution of said command by said drive apparatus, said result being read by said host apparatus when an interrupt signal is sent from said interface apparatus to said host apparatus.

7. An information processing apparatus for issuing a command to be executed by a drive apparatus, said information processing apparatus comprising:
a memory for storing a command queue including commands issued by said information processing apparatus; and
a part for writing an address for accessing said command queue to an interface part provided between said information processing apparatus and said drive apparatus.

8. An information storage for executing a command issued by a host apparatus, said information storage comprising:
a part for receiving a command issued by said host apparatus from an interface part provided between said host apparatus and said information storage, a result of execution of said command being read by said interface part.

9. An interface method used by an interface apparatus provided between a drive apparatus and a host apparatus in which said drive apparatus executes a command issued by said host apparatus, said interface method comprising the step of:
reading a command from a command queue including commands issued by said host apparatus and sending said command to said drive apparatus.
